(19) United States
(12) Patent Application Publication
(10) Pub. No.: US 2005/0205582 A1
(43) Pub. Date: Sep. 22, 2005

(54) Titanium based composite cookware

(75) Inventor: Stanley Kin Sui Cheng, Vallejo, CA (US)

Correspondence Address: EDWARD S. SHERMAN, ESQ., 3554 ROUND BARN BLVD., SUITE 303, SANTA ROSA, CA, 95403, US

(73) Assignee: Meyer Intellectual Properties Ltd.

(21) Appl. No.: 11/083,595

(22) Filed: Mar. 18, 2005

Related U.S. Application Data
(60) Provisional application No. 60/554,736, filed on Mar. 19, 2004.

(51) Int. Cl. A47J 27/00

(52) U.S. Cl. 220/573.3

(57) ABSTRACT

Article of cookware has upright walls and surrounding bottom-cooking surfaces that are both formed from titanium or an alloy thereof at a first thickness. The cooking vessel also has a thicker bottom formed of a material more heat conductive than titanium, thus allowing the vessel to be of significantly lighter weight, or have superior uniformity of heating due to a thicker bottom formed of a more heat conductive materials. The bottom is optionally formed of anodized aluminum as the titanium walls withstand the corrosive environment of the anodizing bath.

### CROSS REFERENCE TO RELATED APPLICATIONS

This application claims priority from U.S. Provisional Patent Application Ser. No. 60/554,736, filed Mar. 19, 2004, the disclosure of which is incorporated herein by reference in its entirety.

### BACKGROUND OF INVENTION

The present invention relates to improved cookware, particularly pans having lighter weight and superior durability and lifetime.

Prior methods of constructing cookware involve forming a pot or pan from a single sheet of stainless steel, aluminum or copper, which may include a laminate construction. Preferably, the pans bottom is constructed totally either of aluminum or copper, or a laminated construction thereof to provide improved heat transfer to rapidly heat the pan, for quick responsiveness to the applied heat, and evenly heat the foodstuff contained therein.

Recently anodized aluminum pans have found favor in the marketplace, due to the initial appearance in a dark gray or charcoal color, and superior hardness of the surface, which avoids marring, or scratching from cleaning or scraping with cooking utensils.

Although anodized aluminum cookware offers many advantages, it can also have disadvantages for some consumers. It should be appreciated that this is because of the higher specific strength, that is yield strength to density, stainless steel over aluminum. Pans with stainless steel wall can are generally lighter, as the stainless steel forming the entire upright wall surface, is much thinner than a correspondingly strong aluminum wall. For example, anodized aluminum cookware is considerably heavier despite the lower density of aluminum as compared to stainless steel, as the walls need to be sufficiently thick to insure structural integrity, whereas a laminate of stainless steel cladding over aluminum or aluminum/copper composite bottom pan is significantly lighter. Thus, in all aluminum pans, although an increase in bottom thickness would be desired to improve the uniformity of heating, a compromise is required due to the mass of the walls and their overall effect on the pans total weight.

Also, although anodized pans are initially of a pleasing appearance, they do stain or tarnish readily when high acidity foods are cooked therein, and in fact will even take on a whitish appearance as the porous black oxide is removed or reduced, revealing bare aluminum metal.

It is an object of the invention to provide cookware that is light in weight, but at least equivalent in cooking performance to conventional cookware.

It is therefore a first object of the present invention to provide cooking pans with superior heating characteristics, yet maintain a lightweight.

It is also an object to provide pans of high durability that are more stain resistant than conventional anodized aluminum cookware.

### SUMMARY OF INVENTION

In the present invention, the first object is achieved by fabricating a cooking pot or pan with substantially upright walls formed of titanium metal or an alloy thereof, and the bottom-cooking surface of at least one or more layers of copper or aluminum for heat transfer.

A second aspect of the invention is characterized in that the bottom layer is substantially thicker than convention pans.

Another aspect is achieved by forming the bottom of the pan from aluminum, and then treating the pan in an anodized bath to convert the outer aluminum layer to hard-anodized aluminum oxide, while the interior and at least a portion of the exterior walls can retain the metallic appearance of titanium.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a cross-sectional elevation of a first embodiment of the invention.

FIG. 2 is a cross-sectional elevation of a second embodiment of the invention.

FIG. 3 is a perspective illustration showing the bottom of the cooking vessels of FIG. 1 and FIG. 2 after anodizing treatment for the aluminum.

FIG. 4A, B and C are a sequence of cross-sectional elevations illustrating an alternative embodiment for fabricating the embodiment of the invention illustrated in FIG. 1.

FIG. 5A, B and C illustrate alternative embodiments for forming an intermediate assembly prior to forming the fluid containing cooking vessel from a substantially planar sheet or laminate of metals.

FIG. 6A, B and C are a sequence of cross-sectional elevations illustrating a method of fabricating an alternative embodiment of the invention.

### DETAILED DESCRIPTION

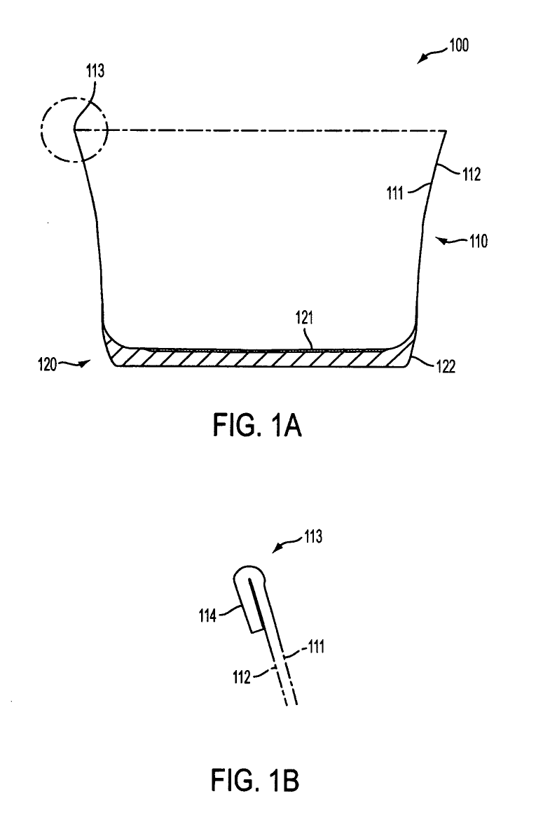

In accordance with the present invention, FIG. 1A illustrates the construction of a composite cookware vessel 100 having substantially vertical or upstanding wall 110 disposed about and connected to a heat-conducting base or bottom portion 120 thus forming a fluid retaining container with an open top. The one or more handles that are conventionally disposed on the outer surface of cookware are omitted merely for clarity. The walls 110 are constructed of titanium metal or an alloy thereof to provide structural integrity, yet minimize the overall weight of the cooking container, whereas while the bottom 120 has an interior surface 121 of titanium or related alloys, it is preferably constructed to include at least one layer of a material 122 with higher thermal conductivity than titanium, such as copper or aluminum. The bottom is optionally constructed of a one of more heat conductive material. In the embodiment in which the bottom consists entirely of aluminum the preferred thickness is about 4 to 7 mm whereas the titanium walls preferably have a thickness of about 0.7 mm to about 1.5 mm, and more preferably about 1 mm. In more preferred embodiments the aluminum layer is encapsulated by an 18/0 type stainless steel cap, such as 420 or 430 grade so as to provide a susceptor layer for induction heating of the cooking vessel.

FIG. 1B illustrates in further detail rim region 113 of upright wall 10 of vessel 100, corresponding to the encircled region in FIG. 1A. The outer extreme edge 114 of wall 111 is folded over to contact the adjacent outside wall 112, thus doubling the thickness of the rim portion 113 and increasing the strength of the vessel 100.

In one embodiment, the cooking vessel of FIG. 1 is formed according to conventional procedures of first drawing a titanium disc to form a bowl like preform, which forms the fluid containing vessel. The bowl like preform is then impact bonded to a thicker disk shaped member that forms the outer portion of the bottom section of the vessel. By providing a thicker layer of a more thermally conductive material, the temperature across the bottom of the pan or vessel is more uniform during use, overcoming the potential for temperature non-uniformity due to the lower thermal conductivity of titanium, or other materials used in conjunction therewith that form the bottom section of the cooking vessel. Other methods of providing a thick, heat conductive base include encapsulation of for example a copper layer, between a plurality of multiple drawn vessels. Upon impact or friction bonding the multiple vessels encapsulate the generally thicker metal disc disposed there between. This permits the selection of different materials for the inner and outer surface of the pan, as well as for protecting the thermal conductive materials from tarnishing or scratching. Thus in forming the cooking vessel of FIG. 1, an aluminum disk is bonded to the bottom of the titanium vessel, such that the interior surface finish of the pan, surface 111 and 121, have the same composition as the outer wall surface 112 of the cooking vessel. As will be further described with respect to various alternative embodiments, the impact bonding method enables the deployment of a variety of materials on the inside and outside of the pan to improve the functional performance, as well as create a variety of styles to suit the consumers tastes and the freedom to select from numerous colors and styles of cookware.

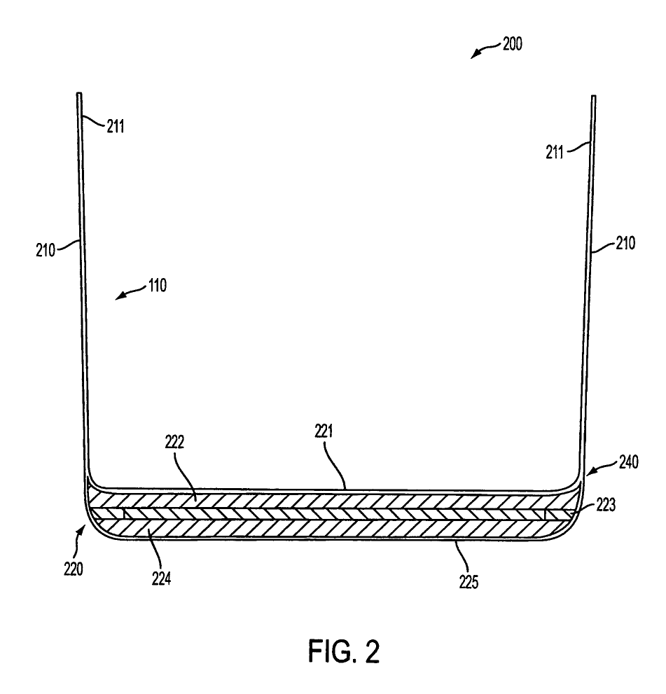

FIG. 2 illustrates an alternative embodiment in which a multiple layer disk forms the bottom surface 220 of the cooking vessel 200. Cooking vessel 200 has a composite construction is which the walls 110 are titanium or an alloy thereof, and the bottom 220 is a composite construction in which layers of various conductive materials are laminated. The multiple layer bottom 220 includes a layer of copper 223 laminated between aluminum layers 222 and 224. As a pre-formed titanium bowl having titanium walls 110 is bonded to the laminated disk that forms bottom 220, the inside surface of the vessel, the interior walls 211 and the interior bottom surface 221 are entirely titanium, or an alloy thereof. The upper 222 and lower 224 aluminum layers surround and effectively sandwich an intervening copper layer 223. The copper layer 223, having a higher thermal conductivity than the adjacent aluminum layer 222 and 224, spreads heat laterally from the bottom layer 224, such that the temperature profile across the interior bottom surface 221 of the pot 200 is relatively uniform, despite variations in the burner or flame pattern of the heating element. Optionally, another layer of metal, such as stainless steel, 225, can protect the outer aluminum layer. Alternatively, as will be further described in other embodiment layer 225 is aluminum oxide forming by anodizing aluminum layer 224. The greatest versatility of a pot or pan with respect to heating element spatial variations is achieved when the conductive layer(s) in the bottom are relatively thick. The practical limitations of increasingly thicker bottom layers are the ultimate weight and cost of the cooking vessel. Thus, it should be appreciated that by using titanium to form at least the vertical walls of a pot, the thickness of the bottom layer can be increased substantially over that deployed in alternative constructions.

It should be appreciated that to alter the cooking characteristics of different size and shape vessels, it may be desirable for the exterior aluminum layer to extend a varying degree up the external wall of the cooking vessel. To the extent the disk used to form the bottom of the vessel is aluminum, it more readily deforms than the titanium preformed bowl, and hence extends to form a least a lower portion of the exterior walls of the vessel forming a junction 240 with the exterior titanium wall 210. To the extent that the aluminum disk is also pre-shaped to a bowl like preform, that substantially conforms to the shape of the bottom half of the titanium preform, it is possible to increase the height of the lower wall that is formed from aluminum.

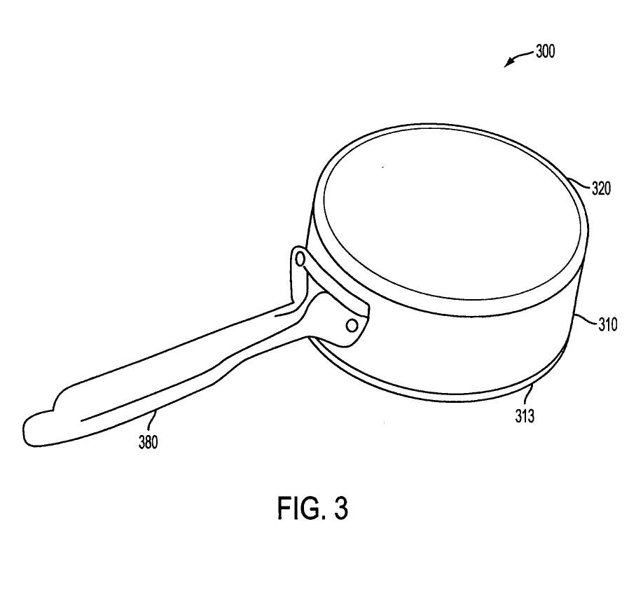

FIG. 3 is a perspective view of a cooking vessel 300 in an inverted position.

The vessel has a handle 380 and an upper rim 313. While this vessel's construction is substantially similar to FIGS. 1 and 2, the properties and external appearance are unique as a result of placing the vessel in an anodizing bath. The anodizing process is a well-known electrochemical oxidation process that converts the exposed aluminum surface to a thick and readily adherent layer of aluminum oxide. It should be noted that the bottom portion 320 of vessel 300 would have a matte black or deep charcoal colored finish, while the titanium portion 310 can be cleaned by polishing after anodizing, and hence retain the reflective metallic finish. Such contrasting finishes provide a distinguishing aesthetic characteristic to the pan, as well as a durable scratch resistant outer surface, as the anodized aluminum bottom surface is much harder than metals. While other materials, such as stainless steel, resist acidic foods, they are not easily combined with an outer anodized aluminum finish, as even stainless steel would corrode in the strongly acidic bath used to anodize aluminum metal. This construction is a preferred embodiment, as the titanium interior provides the resistance to highly acidic foods, which would stains or tarnish an interior anodized aluminum finish, yet has a more durable bottom surface. The durable bottom surface is resistant to abrasion from burner supports and stovetops, yet the entire cooking vessel is lighter in weight than a vessel formed entirely of anodized aluminum. Thus by forming the upright walls of the vessel from titanium, a unique combination of exterior durability and interior chemical resistance is achieved.

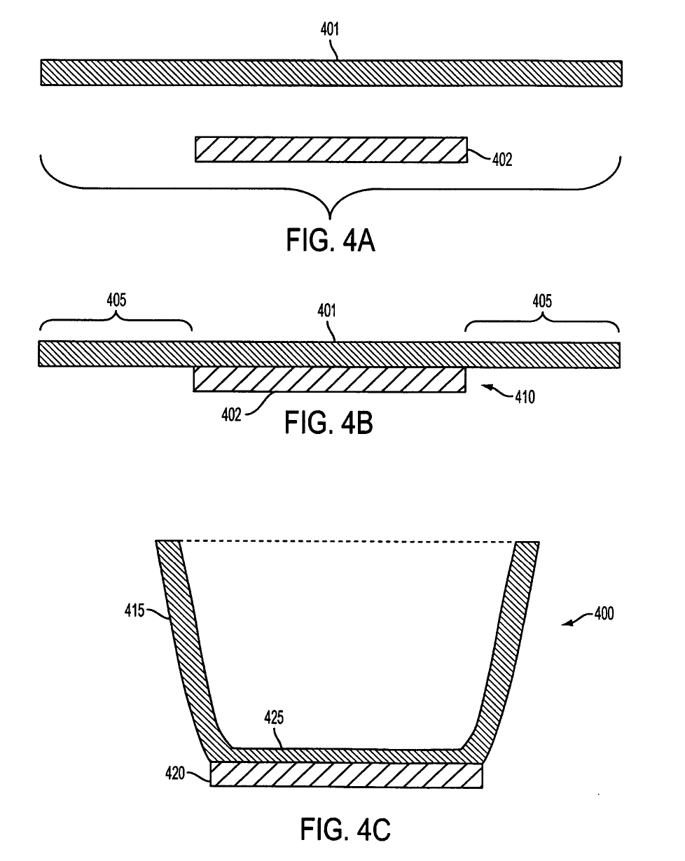

FIG. 4A, B and C illustrate a sequence of fabrication steps used to form the vessel of FIG. 1 in an alternative embodiment of the invention. In the first step of this method, illustrated by FIG. 4A, a first disk 401 that comprises titanium or a suitable alloy thereof, to provide lightweight and high strength, is concentrically aligned with a smaller diameter disk 402 of a material, preferably aluminum, that has a higher thermally conductivity than titanium. Such higher conductivity materials includes copper, as well as laminates of aluminum and copper, and in particular laminates in which copper is surrounded by aluminum layers. The first disk 401 is then bonded to the second disk 402 to form assembly 410 in FIG. 4B. Assembly 416 is preferably formed by impact or friction bonding the first disk 401 to the second disk 402.

The next step in fabrication of vessel 400, regardless of the method to form or create the bonded disk assembly 410, is a deep drawing process that uses a pair of mail and female forming dies that determine the shape of the finished vessel 400. Thus, bonded disk assembly 410 is next inserted between the forming die (not shown), which on the application of pressure cause the deep drawing of assembly 410 forming vessel 400, as shown in FIG. 4C. It should be noted that the area between of the titanium disk outside the aluminum disk 405 in FIG. 4B is primarily drawn to form the walls 415 of the cooking vessel, whereas the aluminum 402 generally forms at least the exterior bottom surface 420, whereas the interior bottom surface 425 is formed of the titanium in disk 401.

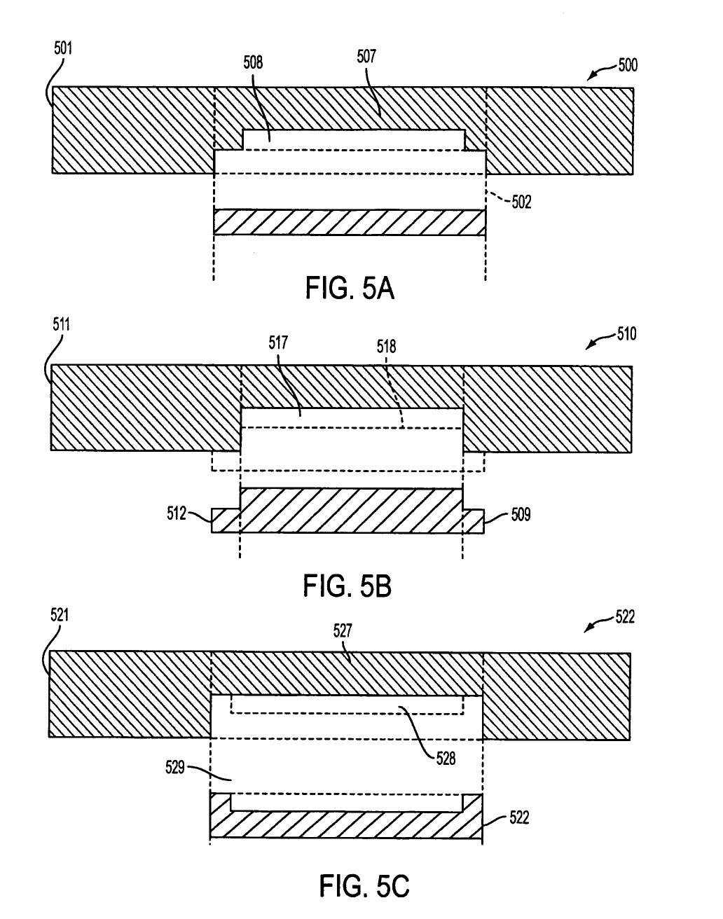

Alternative methods of aligning the disks to optimize adhesion and provide dimensional control during impact bonding are illustrated in FIG. 5A, B and C. The position of the smaller aluminum disk adjacent the larger titanium disk prior to impact bonding or forming is shown in dashed lines to highlight that a gap is provided between the disks prior to impact bonding. Thus, during impact bonding the aluminum, being softer or more malleable than titanium, will flow into this gap resulting in better adhesion to the adjacent titanium disk or plate. Further it is also preferred that at least one disk has a groove or pocket for receiving and co-axially aligning the other disk. Thus in the various combinations shown in FIG. 5A, B and C, the disks no longer have a planar mutual interface, contrary to the embodiment shown in FIG. 4B. It should be appreciated that as a variety of alternative configuration of grooves and mating features can provide the desired gap these Figures are intended to illustrate non-limiting examples.

Thus, in the example of FIG. 5A, a stepped circular recess 508 is formed in the center of the titanium disk 501. Accordingly, when the aluminum disk 50 is centered with respect to the titanium disk 501, by placing it in the upper step of the recess 508, a gap 507 will remain in assembly 500 prior to impact bonding and forming operations.

Likewise in FIG. 5B, a bevel 509 is provided on the outside edge of the aluminum disk 512, while a circular hole 518 is formed in titanium disk 511. The thickness of the bevel 509 in aluminum disk 502 is less than the depth of the hole 518, thus preventing the full insertion of the aluminum disk 512 into the titanium disk 511. This results in the intervening gap 517 before bonding, forming or drawing assembly 510.

In FIG. 5C, the pre-bonded assembly 520 is created by first forming a centrally located circular recess 528 in titanium disk 521. A smaller diameter centrally located circular recess 529 is formed in aluminum disk 522. Thus upon inserting aluminum disk 522 into recess 528 to center the disks, a gap 527 is provided for later fill with aluminum or another malleable metal in disk 22. The thickness of gap 527 is determined by the depth of the circular hole 529 formed in aluminum disk 522. The depth and volume of the gap is generally less than the total volume of aluminum, but will generally depend on the desired final shape and bottom thickness of the cooking vessel. Usually the preferred volume of the gap between the titanium disk and the aluminum disk is generally considerably less than about half the volume of the aluminum disk.

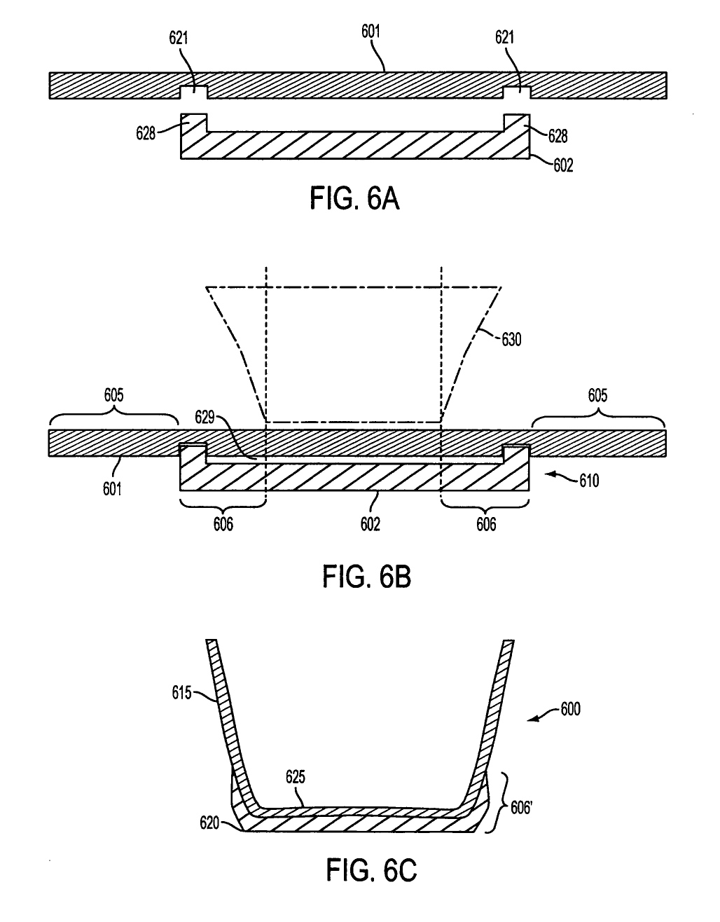

FIG. 6 ii A, B and C illustrate a sequence of fabrication steps used to form the vessel of FIG. 1, in another alternative embodiment of the invention. In the first step of this method, illustrated by FIG. 6A, a first disk 601 that comprises titanium or a suitable alloy thereof, to provide lightweight and high strength, is concentrically aligned with a smaller diameter disk 602 of another material or combination of materials. The first disk 601 is then bonded to the second disk 602 to form assembly 610 in FIG. 6B. Assembly 610 is preferably formed by impact or friction bonding the first or titanium disk 601 to the second disk 602. The titanium disk 601 has an annular groove 621 for receiving the annular wall 628, which extends from the periphery of the second disk 602. The height of wall 628 is preferably greater than the depth of annular groove 621 to leave a gap 629 between the second disk 602 and the titanium disk 601.

In FIG. 6B, the next step in assembly and forming vessel 600 is shown in which the bonded disk assembly 610 is inserted into a forming die (not shown) for deep drawing. The resulting fluid containing vessel 600 is shown in FIG. 6C. In this embodiment the forming die, one-half of which is illustrated in FIG. 6B as a dot-dash line 630, has a somewhat smaller diameter than the aluminum disk 602. As in the other embodiments, the annular perimeter 605 of the titanium disk 601 outside the diameter of the second disk 602, in FIG. 6B is primarily drawn to form the walls 415 of the cooking vessel. In contrast, the second disk 602 forms the exterior bottom surface 620, such that the interior bottom surface 625 is titanium from disk 601. However, in this embodiment a portion of the upright wall 615 in FIG. 6C, will be formed from the annular region 606 (in FIG. 6B) in which second disk overlaps the titanium disks overlap but outside the region that would make contact with the horizontal portion of the forming die 630.Accordingly, in the completed cooking vessel 600 in FIG. 6C a portion 606′ of second disk is exposed on the exterior side surface of the cooking vessel, as upright walls 615 was formed by region 606 in FIG. 6.

It should be appreciated in the embodiments described with respect to FIG. 4, 5 and 6, the impact bonding and deep drawing need not be carried out in separate discrete operations, as they can be performed in the same process of impact or friction bonding when the appropriated shaped forming dies are provided. Further, alternative processes such as brazing and hot rolling may be used to adhere the aluminum disk to a larger titanium sheet or disk.

The final step in the more preferred embodiments of the invention, to fabricate any of the cooking vessels in FIGS. 1, 2, 3, 4 and 6, is an anodizing treatment in which the exposed aluminum surfaces are converted to a harder, more durable aluminum oxide layer. It should be appreciated that while the construction of a pan with a stainless steel interior is well known, it would not be combined with an aluminum exterior for several reasons. First aluminum would scratch easily, and second anodizing the outer aluminum would be difficult, as the stainless steel interior would need to be fully protected from the highly corrosive anodizing bath. Finally, the pan would not be significantly lighter in weight than an all-aluminum anodized pan.

Thus, the titanium composition of the pan enables the use of anodized aluminum for the exterior surface, while avoiding aluminum exposure on the inside of the pan, and reducing the overall weight of the pan. In addition, the cooking performance of the pan is not impaired, as the foodstuffs are uniformly heated irrespective of the generally irregular pattern of temperature on the outside of the pan, due to the fire/burner element characteristics. This benefit is generally achieved when the aluminum has a thickness of at least about 4 mm, although a thickness of from about 5 to 7 mm or more is preferable.

Further, while the titanium surfaces are capable of withstanding the additional optional step of exposure to the anodizing process, used to convert the outer layer of the exposed aluminum to a harder and more durable oxide, they do undergo some oxidation that results in a discoloration from the normally silvery metallic color to a slightly gold cast. Accordingly, unless the gold cast is preferred for aesthetic reasons, a preferred additional step in the process is to burnish the titanium surface to remove the oxide, and thus restore the more silvery color to the titanium metal.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. An article of cookware, comprising:
a) a fluid containing portion having substantially vertical upright walls extending upward from the periphery of an interior cooking surface,
b) an exterior bottom surface attached to the opposite side of the interior cooking surface,
c) wherein said fluid containing portion is formed from titanium metal or an alloy thereof and said exterior bottom surface is formed from a material having a higher thermal conductivity than titanium.

2. An article of cookware according to claim 1 wherein said exterior bottom surface comprises aluminum.

3. An article of cookware according to claim 1 wherein said exterior bottom surface comprises copper.

4. An article of cookware according to claim 1 wherein said exterior bottom surface is a laminate construction having two or more aluminum layers substantially encapsulating a copper layer.

5. An article of cookware according to claim 2 wherein said exterior bottom surface is anodized aluminum.

6. An article of cookware according to claim 5 wherein the anodized aluminum extends at least partially upward along the exterior of the substantially vertical upright walls of the cooking vessel.

7. An article of cookware according to claim 2 wherein the aluminum bottom has a thickness of at least about 5 mm.

8. An article of cookware according to claim 7 wherein the titanium wall has a thickness of at least about 0.5 mm.

9. An article of cookware according to claim 1 wherein the titanium wall has a thickness of at least about 0.5 mm.

10. An article of cookware according to claim 1 wherein the titanium wall has a thickness of at least about 1 mm.

11. An article of cookware according to claim 1 wherein the terminal portion of the titanium wall is folded over itself to form a rim having about twice the thickness as the lower portion of the wall.

12. An article of cookware according to claim 2 wherein the aluminum bottom has a thickness of at least about 6 mm.

13. An article of cookware according to claim 12, wherein the titanium wall has a thickness of at least about 0.7 mm.

14. A method of forming an article of cookware, the method comprising the steps of:
a) providing a first disk that substantially consists of titanium,
b) deforming the titanium disk to form a fluid containing vessel having a bottom surface and substantially vertical upright wall extending upward from the periphery thereof,
c) bonding a second disk of material that has a thermal conductivity greater than that of titanium to the bottom surface of the fluid containing vessel.

15. The method of claim 14 wherein the second disk comprises one or more layers of aluminum or an alloy thereof.

16. The method of claim 15 wherein the second disk is laminated to the exterior of the fluid containing vessel.

17. The method of claim 15 further comprising the step of anodizing the aluminum disk.

18. The method of claim 17 further comprising the step of burnishing at least a portion of the titanium oxidized or tarnished in said step of anodizing.

19. The method of claim 16 wherein said second disk comprises two or more aluminum layers substantially encapsulating a copper layer.

20. A method of forming an article of cookware, the method comprising the steps of:
a) providing a first disk having a first diameter that substantially consists of titanium,
b) providing a second disk having a second diameter smaller than the first diameter that comprises a material having a higher thermal conductivity than titanium,
c) concentrically aligning the first and second disk,
d) bonding the first disk to the second disk,
e) deforming the bonded disks to provide a fluid containing vessel having a bottom surface that includes at least a portion of the second disk and substantially vertical upright wall extending upward from the periphery of the bottom surface.

21. The method of claim 20 wherein said second disk comprises one or more layers of aluminum or an alloy thereof.

22. The method of claim 21 wherein the second disk forms the exterior bottom surface of the article of cookware.

23. The method of claim 20 further comprising the step of anodizing the aluminum that forms at least a portion of the bottom surface of the article of cookware.

24. The method of claim 20 further comprising the step of burnishing at least a portion of the titanium oxidized or tarnished in said step of anodizing.
a) The method of claim 20 further comprising the step of folding the upper edge of the substantially vertical upright wall over itself to form a rim having about twice the thickness of the lower portion of the wall.
